(19) United States
(12) Patent Application Publication
(10) Pub. No.: US 2023/0391605 A1
(43) Pub. Date: Dec. 7, 2023

(54) CARBONATED BEVERAGE DISPENSER

(71) Applicant: Fevertree Limited, London (GB)

(72) Inventors: Andrew James STRATTON, London (GB); Oliver James BATLEY, London (GB); Joshua Aleksander DE GROMOBOY DABROWICKI, London (GB); Patryk GAWLINSKI, London (GB)

(73) Assignee: Fevertree Limited, London (GB)

(21) Appl. No.: 18/205,904

(22) Filed: Jun. 5, 2023

(30) Foreign Application Priority Data
Jun. 6, 2022 (GB) 2208241.6

(51) Int. Cl. B67D 1/12; B67D 1/00

(52) U.S. Cl. CPC B67D 1/1281; B67D 1/0058; B67D 1/0062; B67D 1/0046; B67D 1/0021

(57) ABSTRACT

A dispenser for dispensing a carbonated beverage comprising soda and at least one additive, the carbonated beverage dispenser comprising a compensator, the compensator comprising: an outer body defining a compensator chamber, an inlet, and an outlet, an inner body arranged within the compensator chamber and between the inlet and the outlet, wherein a gap is defined between the inner body and the outer body for regulating the flow rate of soda passing between the inlet and the outlet, and a control element configured to receive a user input from a user and to control the size of the gap in dependence on said user input, wherein, for a given user input, the control element moves the inner body relative to the control element to a first extent and the outer body relative to the control element to a second extent, the first extent being non-equal to the second extent.

### CROSS REFERENCE TO RELATED APPLICATION

This application claims foreign priority under the Paris Convention and 35 U.S.C. § 119 to GB patent application number 2208241.6, filed Jun. 6, 2022 with the United Kingdom Patent Office, the entire contents of each of which are incorporated herein by reference as if set forth verbatim.

### FIELD OF THE INVENTION

The present disclosure relates to a carbonated beverage dispenser.

### INTRODUCTION

Carbonated beverages (also known as carbonated drinks or fizzy drinks) are beverages that contain dissolved carbon dioxide. An example of a carbonated beverage is a soda drink, which comprises a soda base (i.e., carbonated water) mixed with additives. Tonic water is one such soda drink. Tonic water has acquired a huge amount of popularity in recent years, particularly in view of a revival of cocktails such as a gin and tonic. Tonic water is often flavoured with additives in the form of citric acid, quinine and sugar which give it a distinct sour-bitter-sweet taste. Other flavourings such as botanicals or fruit flavourings may be added to provide flavoured tonic waters.

One way to serve carbonated beverages in high volume is to make use of a soda gun. A soda gun typically involves mixing soda with at least one additive, and then dispensing the mixture into a drinking receptacle for consumption. Different additives can be selected and added to select different carbonated beverages. Since only one tool, i.e., the soda gun, can be used to dispense a large variety of different carbonated beverages, there are huge savings in space at the bar, and in time for the barperson.

However, when using soda guns, it is difficult to maintain the characteristics of carbonated beverages, and especially a high-quality tonic water. A high-quality tonic water typically has a high carbonation level: higher than the carbonation level of many other carbonated beverages. For example, premium tonic waters and other premium (non-alcoholic) soda drinks have a carbonation of at least 4 volumes of CO₂, while typical non-premium soda drinks and non-premium tonic waters have a carbonation of 2.5-3.5 volumes of CO₂, and beers typically 2.2-2.6 volumes of CO₂. Carbonation can be maintained at a relatively high level when the tonic water is stored in bottles or cans in relatively small quantities. However, when dispensing large volumes of tonic water through a soda gun maintaining high carbonation levels is more challenging.

This is because when soda guns are used to dispense carbonated drinks into a drinking receptacle, outgassing occurs in the carbonated drinks, i.e., a foaming of the dispensed drink, which leads to an undesirable and unwanted drop in carbonation in the dispensed drink. The dispensed carbonated drink is therefore flatter and less desirable to the consumer.

As a result, high quality tonic waters have typically only been served by way of bottles or cans.

The carbonated beverage dispenser according to the present invention aims to solve at least some of the problems associated with the prior art.

### SUMMARY OF THE INVENTION

According to a first aspect of the invention, there is provided a carbonated beverage dispenser for dispensing a carbonated beverage comprising soda and at least one additive, the carbonated beverage dispenser comprising a compensator for regulating the flow rate of soda, the compensator comprising:
an outer body defining a compensator chamber,
an inlet for delivering soda into the compensator chamber, and an outlet for delivering soda out of the compensator chamber,
an inner body arranged within the compensator chamber and between the inlet and the outlet, wherein a gap is defined between the inner body and the outer body for regulating the flow rate of soda passing between the inlet and the outlet, and
a control element configured to receive a user input from a user and to control the size of the gap in dependence on said user input, wherein, for a given user input, the control element moves the inner body relative to the control element to a first extent and the outer body relative to the control element to a second extent, the first extent being non-equal to the second extent.

Precise control of the gap between the inner body and the outer body in this way can be used to ensure a high level of carbonation in the dispensed soda drink. Such precise control is more important for soda drinks, compared to, say, beer, because soda is less viscous than beer, and because the carbonation requirements for high-quality soda are often higher than beer.

In a preferred embodiment, the carbonated beverage dispenser is a soda drink dispenser for dispensing soda drinks, and in particular for dispensing non-alcoholic drinks.

The first extent is optionally larger than to the second extent. In one embodiment, the gap between the inner body and the outer body is fixed.

The control element is optionally rotatable. The user input may be a rotation of the control element.

In one embodiment, the control element takes the form of a differential screw. The differential screw may have a first portion comprising a first thread for engaging the outer body and a second portion comprising a second thread for engaging the inner body. The first thread may have a different thread pitch to the second thread. In one embodiment, the first thread has a smaller thread pitch than the second thread.

Preferably, the first thread has a pitch of between 0.65 and 0.85 mm, and/or the second thread has a pitch of between 0.9 mm and 1.1 mm. When the first thread has a pitch of mm and the second thread has a pitch of 1.0 mm, when the screw is rotated such that the differential screw travels 0.75 mm down relative to the outer body, the inner body is moved 1.00 mm up relative to the differential screw. Accordingly, the inner body only moves 0.25 mm relative to the outer body. The first thread has an ISO Metric thread dimension M8, and the second thread has an ISO Metric thread dimension M6.

For a full rotation of the control element, the control element preferably causes relative longitudinal displacement between the inner and outer bodies of between 0.20 mm and 0.30 mm.

In the middle region of the compensator, this relative longitudinal displacement between the inner and outer bodies brings about a change of a few microns in the gap between the inner body and the outer body, where said gap is measured at a right angle with respect to the outer surface of the inner body and/or the inner surface of the outer body and/or the flow of soda through said gap.

The inner body may be non-rotational with respect to the outer body.

The carbonated beverage dispenser may comprise a rotation stop. The rotation stop may be configured to rotationally fix the inner body with respect to the outer body. Optionally, the rotation stop comprises a grub screw that may connect the inner body to the outer body.

The control element may extend along the same axis as the inner body.

In one embodiment, the control element comprises an engagement portion that protrudes out of the outer body to define an engagement feature for engagement by a user. The engagement portion preferably takes the form of a grip and may be provided at the first portion of the rotatable control element.

The compensator preferably further comprises a cooling conduit arranged within the outer body. Said cooling conduit may be configured to receive a cooling liquid.

Cooling the compensator further reduces outgassing in dispensed soda. Also, it helps to ensure a constant liquid velocity of the dispensed soda, and hence the liquid dispense volume is made more consistent. The cooling liquid may be the soda, which may be circulated through the cooling conduit before or after it is passed through the compensator chamber. Alternatively, instead of using recirculated soda, a cooling conduit separate to the compensator chamber can be used, with a separate cooling liquid. In one embodiment, the outer body is made of a thermally conductive metal such as steel, although other metals or plastics may also be used. Plastic may be preferred because it results in a simplified manufacturing process and reduced costs—all plastic parts may be moulded separately and then welded together. Also, plastic has been found to ensure sufficient heat transfer, and it can be easier to achieve a much smoother finish on plastic parts than on metal counterparts.

Additionally or alternatively, the inner body may be made of steel or plastic. Again, plastic may be preferred because it results in a simplified manufacturing process and reduced costs.

The compensator may comprise a first region proximal to the inlet, a second region proximal to the outlet, and/or a middle region therebetween. The first region may be an upstream region and the second region may be a downstream region of the compensator, relative to the direction of soda flow through the compensator. In one example the upstream region is also arranged above the downstream region, since the direction of flow in this embodiment is downward, but this need not be the case and in other embodiments the flow may be in other directions, with the upstream and downstream regions arranged accordingly.

In the first region, a diameter of the inner body and a diameter of the compensator chamber are preferably approximately constant between the inlet and the middle region.

In this way, in the first region, the gap between the inner and outer bodies is fixed. This is because, regardless of any relative movement between the inner and outer bodies along longitudinal axis L, the gap between the two remains the same. This advantageously provides a fixed pressure drop to fluid passing over.

In the middle region, the or a diameter of the inner body and the or a diameter of the compensator chamber increase at substantially the same fixed rate between the first and the second region.

In this way, in the middle region, the gap between the inner and outer bodies is variable and changes in dependence on the relative lateral movement between the inner and outer bodies along longitudinal axis L. Hence, by way of such longitudinal relative movement between the inner and outer bodies, the pressure drop provided by the compensator can be precisely tuned. This variable pressure drop in the middle region ensures high precision in flow rate calibration.

In the second region, the or a diameter of the inner body and the or a diameter of the compensator chamber preferably decrease at different fixed rates between the middle region and the outlet.

In this way, in the second region, the gap between the inner and outer bodies increases moving down the longitudinal axis L. There is therefore no substantial pressure drop, but the fluid is advantageously decelerated without outgassing. Hence when the fluid can be dispensed at an appropriate rate without losing any carbonation.

The inner body may be substantially cylindrical in the first region, substantially frustoconical in the middle region, and/or substantially conical in the second region.

In one preferred embodiment, an outer surface of the inner body, and/or an inner surface of the inlet and/or an inner surface of the outlet has a maximum surface roughness of 0.1 microns Ra. This smoothness reduces nucleation sites for bubble formation, hence reduces outgassing in the dispensed soda.

In one embodiment, the carbonated beverage dispenser further comprises a soda delivery system comprising a chiller-carbonator for chilling and carbonating soda for the compensator.

Preferably, the soda delivery system further comprises a first soda delivery conduit for transporting soda from the chiller-carbonator to the cooling conduit for cooling the compensator. In this way, chilled and carbonated soda water, which can be regulated by the compensator and then dispensed, is used to cool the compensator itself.

The soda delivery system may further comprise a third soda delivery conduit for transporting soda from the cooling conduit back to the chiller-carbonator for re-cooling and re-carbonisation.

The soda delivery system may further comprise a second soda delivery conduit for transporting soda water from the chiller-carbonator to the compensator for flow-regulation, preferably when selectively operated by a user.

The chiller-carbonator is preferably configured to pressurise soda to between 5.5 bar and 6.9 bar, and more preferably 6.2 bar. The soda is preferably pressured to between 80 and 100 PSI, and more preferably 90 PSI, i.e., between 5.5 bar and 6.9 bar, and more preferably 6.2 bar.

In one embodiment, the carbonated beverage dispenser further comprises an additive dispensing system for dispensing at least one additive. The carbonated beverage dispenser may further comprise a mixing chamber for receiving soda from the compensator and at least one additive from the additive dispensing system and mixing the soda with at least one additive to form a soda-based drink.

The soda and additive(s) are mixed before dispersion—perception is therefore of one liquid being dispensed, as when a bottle is used to serve.

An inner surface of the mixing chamber preferably has maximum roughness of 0.1 microns Ra. This smoothness reduces nucleation sites for bubble formation, hence reducing outgassing in the dispensed mixed soda.

In one particularly preferred embodiment, the mixing chamber further comprises a first opening arranged in the mixing chamber. In this embodiment, the additive dispensing system preferably comprises at least one additive dispenser arranged to dispense at least one additive into the mixing chamber through the first opening. Advantageously, a spacing may be defined between the at least one additive dispenser and the mixing chamber.

In this way, the additive dispensing nozzles never touch the liquids in mixing chamber, and so will never be contaminated thereby. Hence, the additive dispensers do not need to be cleaned. Volume of mixing chamber is preferably sufficient such that the mixing chamber does not overflow depending on pour volume and dispense time.

The first opening may be defined in an upper wall of the mixing chamber and/or the at least one additive dispenser may be arranged above the mixing chamber.

The at least one additive dispenser may advantageously be arranged at an angle with respect to the direction in which the mixing chamber extends such that the least one additive dispenser dispenses soda along the direction of soda flowing through the mixing chamber. This avoids splash back/liquid being splashed out the top of the mixing chamber.

The mixing chamber may further comprise a second opening for receiving soda from the outlet of the compensator, and/or a third opening for delivering carbonated beverage out of the mixing chamber. Each of the first, second and third openings are preferably distinct.

The additive dispensing system may comprise a plurality of additive dispensers each arranged to dispense an additive, a plurality of additive stores for storing each additive, and a plurality of additive delivery conduits for transporting additive from each additive store to the respective additive dispenser for dispensing. This configuration is preferable as it avoids contamination of additives, and hence reduces the need for cleaning.

In one embodiment, the carbonated beverage dispenser comprises a control unit for controlling the carbonated beverage dispenser during dispensing operations. Preferably the control unit is configured to control a dispensing flow of soda and additive such that, at the end of each dispensing operation, the last liquid that passes through the mixing chamber is soda, with no dispensed additive(s).

The control unit is preferably configured to stop the additive dispensing system dispensing an additive into the mixing chamber before the control unit stops the compensator dispensing soda into the mixing chamber. This final amount of soda water acts to clean the mixing chamber, to prevent flavour cross-over with the additive being present in the mixing chamber.

To this end, the inlet of the compensator may be provided with a controller valve to control whether soda is delivered to the compensator, and then to the mixing chamber, and the or each additive dispensers may be provided with a dispenser valve and/or pump to control whether additive is delivered to the mixing chamber. The control unit may be electrically coupled to the controller valve and/or the or each dispenser valve.

In one preferred embodiment, the mixing chamber is removable from the carbonated beverage dispenser. This allows the mixing chamber to be cleaned with ease. Preferably, the mixing chamber is made of material such that it is fully dishwasher safe.

The compensator may comprise a first connection part about the outlet. The mixing chamber may comprise a second connection part about the second opening. One of the first and second connection parts may be male and the other may be female. Preferably, the first and second connection parts fit with a frictional fit.

The carbonated beverage dispenser may comprise the or a control unit for controlling the operation of the carbonated beverage dispenser. The control unit is preferably configured to detect whether the mixing chamber has been removed from the carbonated beverage dispenser, and/or to prevent the compensator and/or the additive dispensing system from dispensing when the mixing chamber has been removed from the carbonated beverage dispenser.

A magnetic interlock between the mixing chamber and the compensator can be used to facilitate this. The interlock may comprise a magnetic element on one or more of the first and second connection parts and may further comprise a sensor for sensing when the magnetic interlock is engaged. The sensor may be configured to communicate with the controller. Alternatively, the mixing chamber and the compensator can be attached by way of a rubber seal.

The carbonated beverage dispenser may further comprise a carbonated beverage outlet for dispensing carbonated beverage from the mixing chamber. The carbonated beverage outlet is preferably connected to the mixing chamber such that both the mixing chamber and the carbonated beverage outlet are removable from the carbonated beverage dispenser.

This allows the carbonated beverage outlet to be cleaned with ease. Preferably, the carbonated beverage outlet is made of material such that it is fully dishwasher safe. The carbonated beverage outlet may comprise a spout. The carbonated beverage outlet may be fixedly connected to the mixing chamber.

An inner surface of the carbonated beverage outlet preferably has a maximum surface roughness of 0.1 microns Ra. This smoothness reduces nucleation sites for bubble formation, hence reducing outgassing in the dispensed mixed soda.

According to a second aspect of the invention, there is provided a carbonated beverage dispenser for dispensing a carbonated beverage comprising soda and at least one additive, the carbonated beverage dispenser comprising:
a soda delivery system for providing soda,
an additive dispensing system for providing at least one additive, and
a mixing chamber for receiving soda from the soda delivery system and at least one additive from the additive dispensing system, and for mixing the soda with the at least one additive to form a soda drink,
wherein the mixing chamber comprises an opening and the additive dispensing system comprises at least one additive dispenser arranged to dispense at least one additive into the mixing chamber through the first opening, and wherein a spacing is provided between the at least one additive dispenser and the mixing chamber.

In this way, the nozzles never touch the liquids in mixing chamber, and so will never be contaminated thereby. Hence, the additive dispensers do not need to be cleaned regularly. Volume of mixing chamber is preferably sufficient such that the mixing chamber does not overflow depending on pour volume and dispense time.

The first opening is preferably defined in an upper wall of the mixing chamber, and/or the at least one additive dispenser may be arranged above the mixing chamber.

According to a third aspect of the invention, there is provided a carbonated beverage dispenser for dispensing a carbonated beverage comprising soda and at least one additive, wherein the carbonated beverage dispenser comprises:
a compensator for regulating the flow rate of soda prior to dispensing, the compensator comprising an inner body and an outer body, with a gap therebetween, the gap defining a flow path for soda as it is dispensed,
a cooling conduit for cooling the compensator, the cooling conduit being arranged in the outer body,
a chiller-carbonator for chilling and carbonating soda, and
a first soda delivery conduit for transporting soda from the chiller-carbonator to the cooling conduit for cooling the compensator.

In this way, chilled and carbonated soda water, which can be regulated by the compensator and then dispensed, is used to cool the compensator itself.

The carbonated beverage dispenser may further comprise a second soda delivery conduit for transporting soda water from the chiller-carbonator to the compensator for flow-regulation, preferably when selectively operated by a user.

The soda delivery system may further comprise a third soda delivery conduit for transporting soda from the cooling conduit back to the chiller-carbonator for re-cooling and re-carbonisation.

The outer body may comprise a first outer body part and a second outer body part, and the cooling conduit may be defined between the first outer body part and the second outer body part.

The first outer body part may be an upper outer body part and the second outer body part may be a lower outer body part.

Each of the first outer body part and second outer body part may define a flat meeting surface, which are arranged in contact when the outer body is arranged for use.

Features of any one aspect or embodiment of the invention may be used, alone or in appropriate combination, with other aspects and embodiments as appropriate.

### BRIEF DESCRIPTION OF THE DRAWINGS

FIG. 1 is a schematic view of a carbonated beverage dispenser according to a first embodiment of the invention, the carbonated beverage dispenser comprising a compensator with an inner and outer body and control element, a mixing chamber, at least one additive dispenser, and a carbonated beverage outlet.

FIG. 2 is a cross-sectional side view of the compensator, mixing chamber, at least one additive dispenser, and carbonated beverage outlet of FIG. 1.

FIG. 3 is a cross-sectional side view of the compensator, mixing chamber, at least one additive dispenser, and carbonated beverage outlet of FIG. 1, wherein a first liquid flow path is shown.

FIG. 4a is a perspective view of the inner body of FIG. 1.

FIG. 4b is a cross-sectional side view of the inner body of FIG. 1.

FIG. 5 is a cross-sectional side view of the control element of FIG. 1.

FIG. 6 is a cross-sectional front view of the compensator of FIG. 1.

FIG. 7 is a cross-sectional front view of the compensator of FIG. 1, wherein a second liquid flow path is shown.

FIG. 8a is a back-front perspective view of the mixing chamber and the carbonated beverage outlet of FIG. 1.

FIG. 8b is a front-back perspective view of the mixing chamber and the carbonated beverage outlet of FIG. 1.

FIG. 9 is a cross-sectional back-front perspective view of the mixing chamber and the carbonated beverage outlet of FIG. 1.

FIG. 10 is a cross-sectional side view of a carbonated beverage dispenser according to a second embodiment of the invention.

FIG. 11 is a top-down view of the carbonated beverage dispenser of FIG. 10.

In the figures, the carbonated beverage dispenser is illustrated in an up-right configuration, i.e., in the orientation in which the carbonated beverage dispenser would be used by a user. In the first embodiment, when the dispenser is oriented for use a longitudinal axis L of the compensator extends generally downwards. In the second embodiment, when the dispenser is oriented for use, a longitudinal axis L of the compensator extends upwards at an angle to the vertical. All references to ‘upper’, ‘upward’, ‘downward’, cup′, ‘down’ etc are with reference to these up-right orientations of the dispensers. However, it will be appreciated that other orientations are possible. An L, P co-ordinate system is used to refer to particular directions and axes relative to the compensator body, and the co-ordinate system is shown in the figures.

### DETAILED DESCRIPTION OF EMBODIMENTS OF THE INVENTION

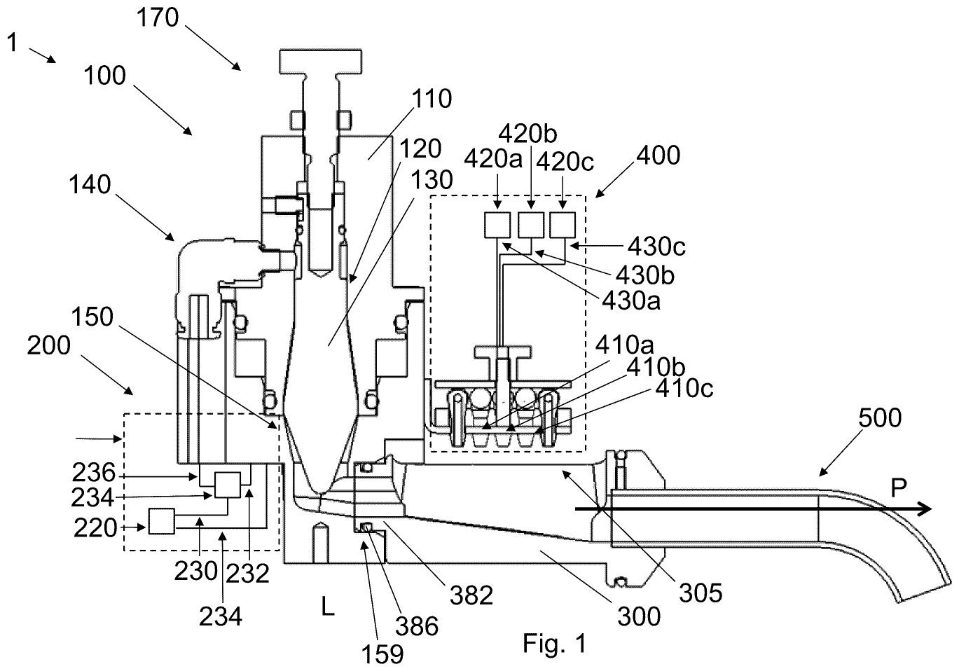

FIG. 1 shows a carbonated beverage dispenser 1, exemplified in the form of a (non-alcoholic) soda drink dispenser, according to an embodiment of the invention. The carbonated beverage dispenser 1 is configured to dispense carbonated beverages such as soda drinks including tonic water.

A soda drink is any drink comprising soda, i.e., carbonated water, and at least one additive such as citric acid, sugar, quinine, botanicals and/or other flavourings. At least one additive is preferably in the form of a water-based or alcohol-based liquid. For example, the water-based liquid may contain sugar dissolved therein. Soda and additive(s) are mixed together to form any soda drink of choice.

The carbonated beverage dispenser 1 comprises a compensator 100 that is configured to regulate the flow rate of liquids, i.e., the soda, passing therethrough. This is to ensure a high level of carbonation in the dispensed drink. This compensator 100 is particularly effective at providing resistance to offset the increased pressure needed for highly pressured drinks such as high-quality tonic waters. Without a compensator 100, a turbulent water out-flowing causes an unwanted and undesirable flattening in dispensed carbonated beverage.

In addition to the compensator 100, the carbonated beverage dispenser 1 comprises a soda delivery system 200 for delivering soda to the compensator 100, i.e. for flow regulation, an additive dispensing system 400 for dispensing at least one additive, and a mixing chamber 300 for receiving soda from the compensator 100 and at least one additive from the additive dispensing system 400, and mixing the soda with the at least one additive to form a soda drink (see FIG. 1). The carbonated beverage dispenser 1 further comprises a carbonated beverage outlet 500 for dispensing the soda drink mixed in the mixing chamber 300 into, for example, a drinking receptacle (not shown) for consumption. The carbonated beverage dispenser 1 is also provided with a control unit (not shown) for controlling the operation thereof.

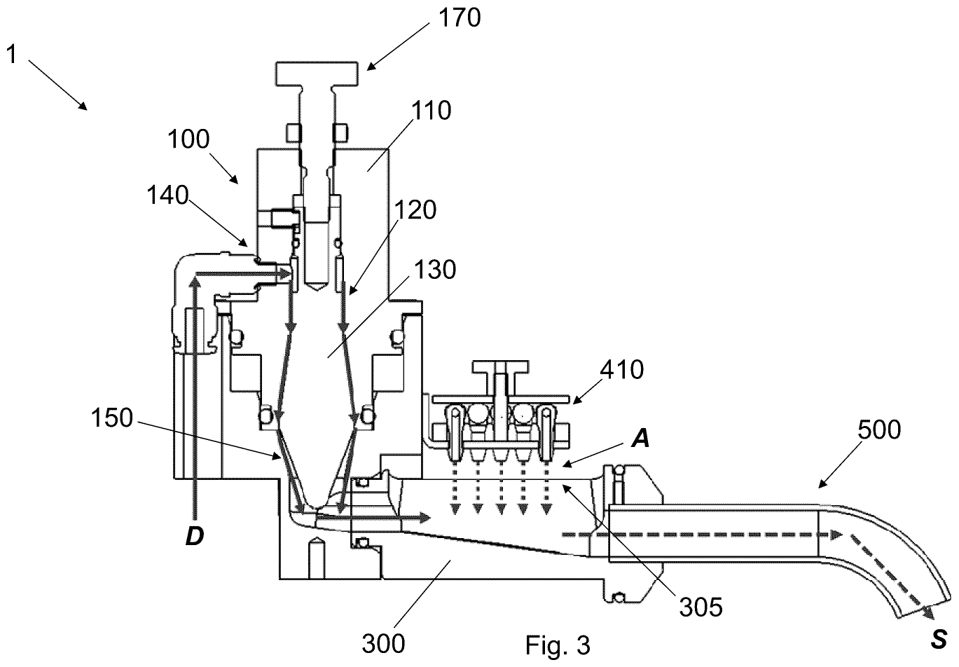

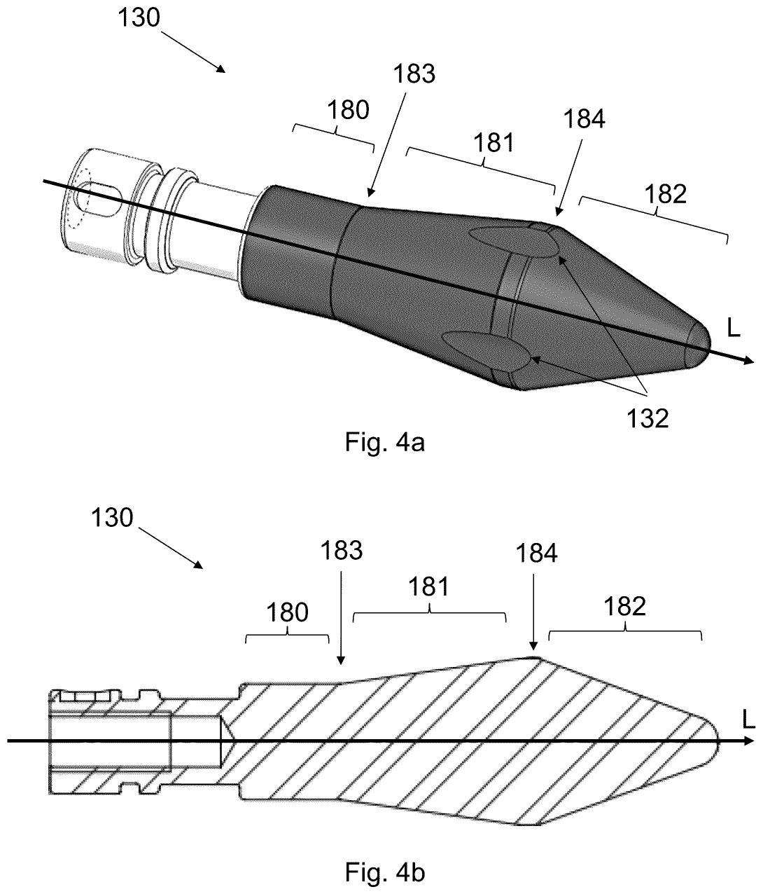

FIG. 3 shows the general flow of liquids through the carbonated beverage dispenser 1. Soda (solid arrow D) is directed from the soda delivery system, through the compensator 100 and into the mixing chamber 300. The additive dispensing system 400 dispenses at least one additive or additive mixture (dotted arrow A) into the mixing chamber 300. In the mixing chamber 300, the soda and the at least one additive are mixed together to form a soda drink. The soda drink (dashed arrow S) then passes through the carbonated beverage outlet 500 for dispensing.

It can therefore be understood how the carbonated beverage dispenser 1 both (i) prepares the carbonated beverage (by mixing the soda and the additive(s) in together), and (ii) dispenses the carbonated beverage with minimal undesirable reduction in carbonation in the dispensed product. Since the soda and additive(s) are mixed before dispersion, there is the perception that only one liquid is being dispensed from the carbonated beverage dispenser 1, and so gives the same impression of when a bottle is used to serve a soda drink.

The dispense unit 1, and especially the compensator arrangement, is specifically designed to control the flow and carbonation of the soda drink during the dispense process, to maintain the premium characteristics of the soda drink, whilst allowing for high volume dispensing.

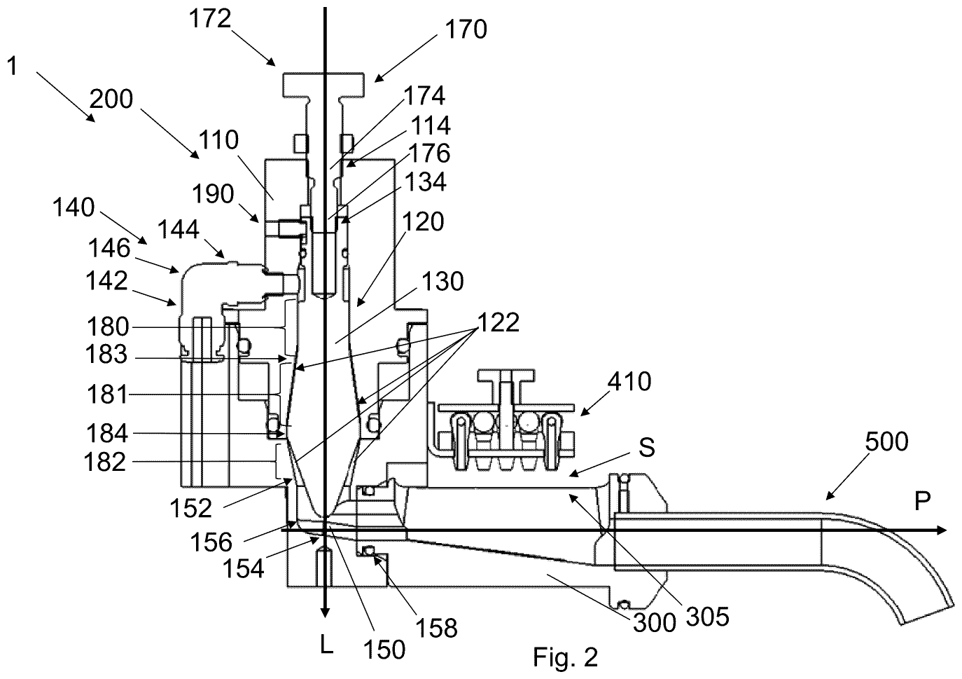

To regulate the flow rate of soda, the compensator 100 comprises an outer body 110 defining a compensator chamber 120, an inlet 140 for delivering soda into the compensator chamber 120, and an outlet 150 for delivering soda out of the compensator chamber 120. The compensator 100 also comprises an inner body 130 arranged within the compensator chamber 120 and between the inlet 140 and the outlet 150, as best seen in FIG. 2. Between the inner body 130 and the outer body 110, the compensator 100 defines a narrow gap 122 which regulates the flow rate of soda passing between the inlet 140 and the outlet 150.

The size of the gap 122 affects the flow rate of the liquid through the compensator 100, which affects the amount of outgassing, and hence the carbonation of the final carbonated beverage. Careful control of the gap 122 is therefore important in controlling flow rate, and quality of the dispensed drink.

To control the size of this gap 122, the compensator 100 further comprises a control element 170, as will be described in more detail below, the control element 170 is configured to receive a user input from a user and to control the size of the gap 122 in dependence on said user input. The control element 170 is configured such that, for a given user input, the control element 170 moves the inner body 130 relative to the control element 170 to a first extent and the outer body 110 relative to the control element 170 to a second extent, the first extent being non-equal to the second extent. This provides a relative movement between the inner body 130 and the outer body 110, which changes the size of the gap.

This particular arrangement of the control element 170 allows for precise control of the gap 122 between the inner body 130 and the outer body 110, and in particular allows for more precise control than if the control element only moved the inner body 130 or outer body 110 directly. In this way, the compensator 100 is able to ensure a high level of carbonation in the dispensed carbonated beverage. This is particularly important for soda, compared to, say, beer, because soda is less viscous than beer, such that the flow rate is more sensitive to changes in flow restriction, and because the carbonation requirements for soda are often higher than beer, meaning that quality is more affected by outgassing.

To simplify cleaning, the mixing chamber 300 comprises a first opening 305 and the additive dispensing system 400 comprises at least one additive dispenser 410 arranged to dispense at least one additive into the mixing chamber 300 through the first opening 305. A spacing S is provided between the at least one additive dispenser 410 and the mixing chamber 300.

In this way, the at least one additive dispenser 410 never touch the liquids in mixing chamber 300, and so will never be contaminated thereby. Hence, the additive dispensers 410 do not need to be cleaned regularly.

More detail about each of the components of the carbonated beverage dispenser 1 will now be discussed in turn.

Turning to the compensator 100 first, as best shown in FIG. 2, the inner and outer bodies 130, 110 of the compensator 100 both extend along longitudinal axis L, and are preferably symmetrical about that longitudinal axis L. The outer body 110 encloses the inner body 130 on all sides along the longitudinal axis L. In this embodiment, the longitudinal axis L is arranged vertically.

The inner and outer bodies 130, 110 define first or upstream, middle and second or downstream regions 180, 181, 182 in the compensator chamber 120. The first and middle regions 180, 181 are joined by an upstream intermediate region 183. The middle and downstream regions 181, 182 are joined by a downstream intermediate region 184, which corresponds to the widest point of the inner body 130 and of the compensator chamber 120. In this embodiment, the first region 180 is an upper region 180 and is arranged above the second region 182 which is a lower region 182.

In the first region 180, the inner body 130 and the compensator 120 extend substantially downwards, with parallel walls. In other words, a diameter of the inner body 130 and a diameter of the compensator chamber 120 are approximately constant when moving downwardly along the longitudinal axis L. In this way, the angle defined between the outer surface of the inner body 130 and the longitudinal axis L is substantially the same as the angle defined between the inner surface of the outer body 110 at each point along the L axis in the first region 180, and these angles are each approximately 0°.

In the first region 180, the gap 122 between the inner and outer bodies 130, 110 is fixed at around 70 microns. This is because, regardless of any relative movement between the inner and outer bodies 130, 110 along the longitudinal axis L, the gap 122 between the two remains the same. This advantageously provides a fixed pressure drop to fluid passing thereover.

In the middle region 181, the inner body 130 and the compensator 120 flare out at the same fixed rate. In other words, the diameter of the inner body 130 and the diameter of the compensator chamber 120 increase at substantially the same fixed rate when moving downwardly along the longitudinal axis L. In this way, the angle defined between the outer surface of the inner body 130 and the longitudinal axis L is substantially the same as the angle defined between the inner surface of the outer body 110 at each point along the L axis in the middle region 181. In one embodiment, the angle defined between the outer surface of the inner body 130 and the longitudinal axis L, and the angle defined between the inner surface of the outer body 110 and the longitudinal axis L, are both fixed at between 5° and 15°, and preferably approximately 10°, at each point along the L axis.

In the middle region 181, the gap 122 between the inner and outer bodies 130, 110 is variable in that it changes in dependence on the relative lateral positions of the inner and outer bodies 130, 110 along the longitudinal axis L. Hence, by way of longitudinal relative movement between the inner and outer bodies 130, 110, the gap 122 can be changed, and hence the pressure drop provided by the compensator can be precisely tuned.

It should be appreciated that in the middle region 181 the gap 122 between the inner and outer bodies 130, 110 is constant along the length of the middle regions when the inner and outer bodies 130, 110 are fixed in place, and is altered only by relative movement between the inner and outer bodies 130. It should also be appreciated that references to the gap 122 here are references to the perpendicular gap, i.e., the perpendicular spacing between the inner and outer bodies 130, 110, taken at right angles to the respective surfaces.

In the second region 182, the inner body 130 and the compensator 120 taper inward at different fixed rates. In other words, the diameter of the inner body 130 and of the compensator chamber 120 decrease at different fixed rates when moving downwardly along the longitudinal axis L. In particular, the angle defined between the outer surface of the inner body 130 and longitudinal axis L is slightly less than the angle defined between the inner surface of the outer body 110 at each point along the L axis in the second region 182 of the compensator 100, so that the gap 122 increases moving down the longitudinal axis L. In one embodiment, the angle defined between the outer surface of the inner body 130 and the longitudinal axis L is fixed between 5° and 15°, and preferably approximately 10°, while the angle defined between the inner surface of the outer body 110 and the longitudinal axis L is fixed between 15° and 25°, and preferably approximately 20°.

In the second region 182, there is no substantial pressure drop, but the fluid is advantageously decelerated without outgassing. Hence when the fluid can be dispensed at an appropriate rate without losing any carbonation. In this way, the inner body 130 is substantially cylindrical in the first region 180, substantially frustoconical in the middle region 181, and substantially conical in the second region 182.

Between the middle and second regions 181, 182 of the inner body 130 is the lower intermediate region 184. The lower intermediate region 184 is a short region with substantially straight vertical sides. The inner body 130 and outer body 110 are shaped so that in the lower intermediate region 184 the outer surface of the inner body 130 sits against the inner surface of the outer body 110, with no circumferential gap therebetween. This close fit ensures that the inner body 130 is centred within the outer body 110.

To allow fluid to flow from the middle region 181 to the second region 182 and across the lower intermediate region 184, despite the close fit described above, at least one flute 132 is defined in the inner body 130 extending across the intermediate region. The flute 132 provides an access channel between the middle region 181 and the second region 182, so that fluid can pass between these regions to be dispensed.

The inlet 140 is fluidly connected to the first region 180 of the compensator chamber 120, while the outlet 150 is fluidly connected to the second region 182 of the compensator chamber 120. Soda therefore travels downwards, at least partially under the influence of gravity, through the above-described gap 122 defined between the inlet 140 and outlet 150, particularly in the second region 182 of the compensator. However, it is the pressure differential across the compensator 120 which accounts for the majority of the movement of soda therethrough.

The inlet 140 is L shaped and includes first and second inlet channels 142, 144 that are integrally connected at a right-angled section 146. The first inlet channel 142 is fluidly connected to the soda delivery system 200 and receives soda therefrom. The first inlet channel 142 extends upwards and parallel to the longitudinal axis L. The second inlet channel 144 is fluidly connected to the first region 180 of the compensator chamber 120. The second inlet channel 144 extends along perpendicular axis P through the outer body 110 of the compensator 100 and into the compensator chamber 120.

The outlet 150 is likewise L shaped and includes first and second outlet channels 152, 154 that are integrally connected at another right-angled section 156. The first outlet channel 152 is fluidly connected to the second region 182 of the compensator chamber 120 and receives regulated soda therefrom. The first outlet channel 152 extends downwards and parallel to the longitudinal axis L. The second outlet channel 154 is fluidly connected to the mixing chamber 300. The second outlet channel 154 extends along perpendicular axis P and through the outer body 110 of the compensator 100 and into the mixing chamber 300.

As stated above, it is the control element 170 that controls the size of the gap 122 between the inner and outer bodies 130, 110. It does this by moving the inner and outer bodies 130, 110 along the longitudinal axis L, i.e., in this embodiment up and down, at different rates in dependence on a given user input. In a preferred embodiment, the user input is rotation of the control element that is effected by a user.

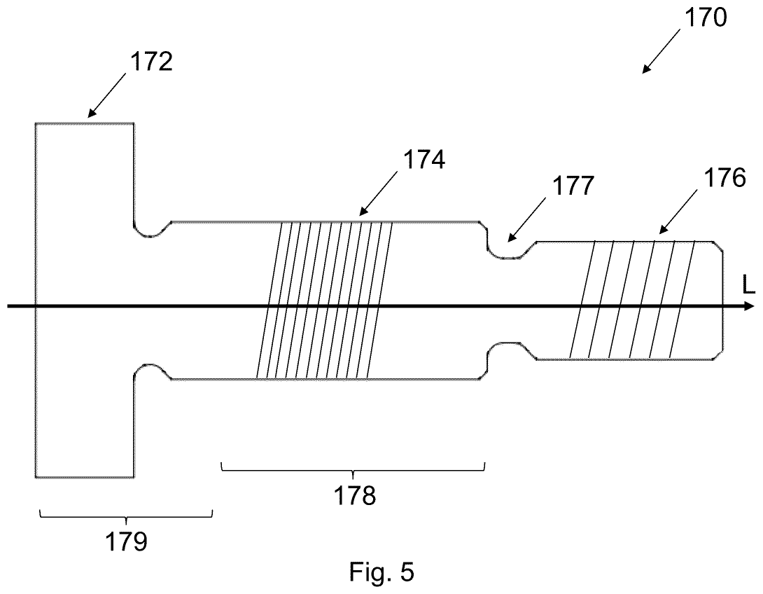

As best shown in FIG. 5, the control element 170 preferably takes the form of a differential screw, although other forms of the control element 170 are possible.

The control element 170 extends along longitudinal axis L and defines an elongate body. The control element 170 has a first portion 174 for engaging the outer body 110 and a second portion 176 for engaging the inner body 130. In this embodiment, the second portion 176 is arranged below the first portion 174 within the compensator 100. In the embodiment shown, the first portion 174 has a greater diameter than the second portion 176, and a narrowed neck region 177 is defined between the first and second portions 174, 176, which acts as a thread relief and facilitates manufacture of the element 170.

The first portion 174 and second portion 176 of the control element 170 define screw-thread surfaces for engagement with the outer and inner bodies 110, 130 respectfully. As best seen in FIG. 2, the outer and inner bodies 110, 130 define corresponding first and second openings that receive the control element, with the openings having corresponding screw-thread surfaces respectively to facilitate this engagement. The first opening of the outer body 110 is defined in a first cavity 114 at the top of the outer body 110, while the second opening of the inner body 130 is defined in a second cavity 134 at the top of the inner body 130. Hence, the control element 170 extends through the first and second cavities 114, 134 in this way.

While a first part 178 of the first portion 174 is arranged within the outer body 110 where it engages with the outer body 110, a second part 179 of the first portion 174 (i.e., above the first part 178) can be arranged outside the outer body 110 for engagement by a user. To facilitate this, the second part 179 of the first portion 174 may define an engagement portion 172, for example in the form of a grip, for engagement/rotation by a user. The second portion 176 of the control element 170 is wholly arranged within the inner and outer bodies 130, 110.

In a preferred embodiment, the inner body 130 is non-rotational with respect to the outer body 110, i.e., it does not rotate along with the rotation of the control element 170. This can be achieved by way of rotation stop that rotationally fixes the inner body 130 relative to the outer body 110: for example, via a grub screw 190 connecting the inner and outer bodies 130, 110, best seen in FIG. 2. In these ways, the inner body 130 can be prevented from rotating with the outer body 110, thereby facilitating relative movement of the inner and outer bodies 130, 110.

Referring back to FIG. 5, the first portion 174 of the differential screw control element 170 has a smaller thread pitch than the second portion 176. This difference in thread pitch means that rotation of the control element 170 brings about a greater relative movement between the control element 170 and the inner body 130 than between the control element 170 and the outer body 110. This means that the differential screw control element 170 is to be rotated clockwise to move the inner and outer bodies 130, 110 closer together, thus reducing flow rate which would be intuitive to the operator. The first portion 174 preferably has a thread pitch of between 0.65 and 0.85 mm, and more preferably 0.75 mm, while the second portion 176 preferably has a thread pitch of between 0.9 mm and 1.1 mm, and more preferably 1.0 mm. These thread pitches are preferable since they are easily machined, though other pitches may be used.

In other embodiments, the first portion 174 of the differential screw control element 170 has a larger thread pitch than the second portion 176. This means that the differential screw control element 170 is to be rotated anti-clockwise to move the inner and outer bodies 130, 110 closer together. In this embodiment, the first portion 174 preferably has a thread pitch of between 0.9 mm and 1.1 mm, and more preferably 1.0 mm, while between the second portion 176 has a thread pitch of between 0.65 and 0.85 mm, and more preferably 0.75 mm.

By virtue of the screw thread engagement, rotation of the control element 170 causes relative displacement along the longitudinal axis L of the outer body 110 relative to the control element 170, and of the inner body 130 relative to the control element 170. Because the screw threads have a different pitch, the relative displacement is correspondingly different. For example, when the first portion 174 has a thread pitch of 0.75 mm and the second portion 176 has a thread pitch of 1.0 mm, a single rotation of the control element means that the differential screw travels 0.75 mm down relative to the outer body 110, while the inner body 130 moves only 1.00 mm up relative to the differential screw. Accordingly, the inner body 130 moves 0.25 mm relative to the outer body 110. Thus, a relatively large movement of the control element causes a very small relative movement of the inner body 130 and outer body 110.

In this way, it is clear how precisely the gap 122 can be controlled by way of a turn of the differential screw. In particular, the control element 170 is configured such that one full rotation of the control element 170 causes a relative longitudinal displacement between the inner and outer bodies 130, 110 of between 0.20 mm and 0.30 mm. It should be appreciated that the change in the gap 122 (i.e., the perpendicular gap between the inner and outer bodies 130, 110) is of a lower magnitude than the magnitude of the lateral movement. This is because in the middle region 181 of the compensator, the outer surface of the inner body 130 and the inner surface of the outer body 110 are angled with respect with respect to the L axis (to the same degree). This relative longitudinal displacement between the inner and outer bodies 130, 110 therefore provides only a change in a few microns in the perpendicular gap 122 between the inner body 130 and the outer body 110, providing particularly fine control of the gap size.

In addition to having a different pitch, the screw threads may have other properties that differ. For example, the screw threads may be of different diameters. In one particular example, the screw thread of the first portion 174 has an ISO Metric thread dimension M8 and the screw thread of the second portion 176 has an ISO Metric thread dimension M6.

To fix the screw 170 in position after manual adjustment, a locknut may be used. Alternatively, a stopping device may be applied to the screw to hold the screw in place and prevent it from rotating except for when the screw is being manually adjusted by a user. Such a device may be preferable over a locknut because access to the screw is limited and so using a locknut can be challenging. In one embodiment the stopping device takes the form of a “clicker” comprising three sprung plastic clips that are applied to the top of the screw 170 and hold it in place.

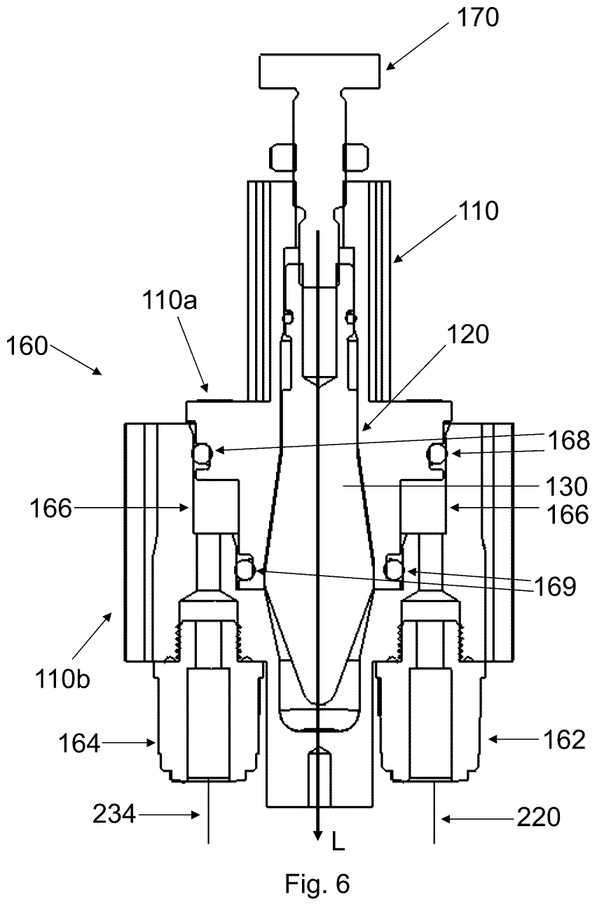

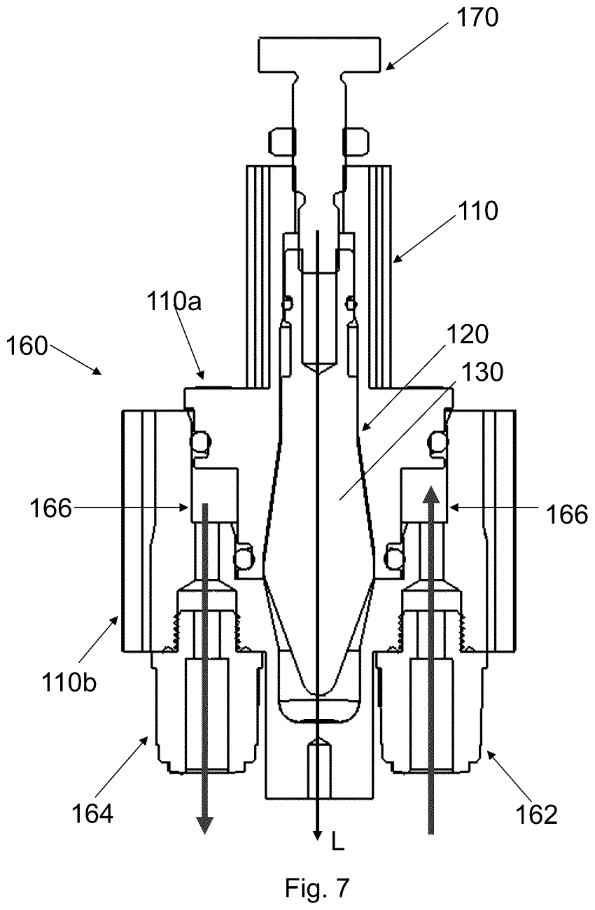

The compensator 100 is preferably provided with a cooling circuit 160 arranged within the outer body 110 to cool the compensator 100, as shown in FIG. 6. Chilled soda is perpetually circulated through the cooling conduit 160 to keep the outer body 110 and compensator 100 at a constant temperature, which is preferably at or close to 0° C., and to prevent stagnation of the soda within the carbonated beverage dispenser 1.

The cooling further helps to reduce outgassing in the dispensed carbonated beverage. Also, the constant temperature helps to ensure a constant liquid viscosity of the dispensed soda, and hence a constant flow rate. This is important to ensure that the liquid dispense volume is consistent with every dispense. Instead of using recirculated soda, a cooling circuit separate to the compensator 100 can be used.

The cooling circuit 100 comprises a cooling inlet 162, a cooling outlet 164, and a cooling conduit 166 extending between the cooling inlet 162 and the cooling outlet 164. The cooling conduit 166 takes the form a channel that extends at least partially around the compensator chamber 120 through the outer body 110. In use, as shown in FIG. 6, soda enters through the cooling inlet 162, then passes around the cooling conduit 166, and then exits out the cooling outlet 164.

In one preferred embodiment, the outer body 110 is made up of upper and lower outer bodies 110a, 110b. These are preferably shaped such that when the upper outer body 110a is arranged on top of the lower outer body 110b in use, the two define the cooling conduit 166 therebetween. This arrangement is easily manufactured since it would not be easy to access the inside of the outer body 110 to machining the cooling conduit 166 if they were formed as one.

The cooling inlet 162 and the cooling outlet 164 are connected to the cooling circuit from underneath the lower outer body 110b. The cooling inlet 162 and the cooling outlet 164 are preferably removably attachable to the lower outer body 110b and hence are removably connectable to the cooling conduit 166. In one embodiment, the cooling inlet 162 and the cooling outlet 164 screw into the lower outer body 110b. This positioning of the cooling inlet and cooling outlet underneath advantageously minimises the overall space envelope of the compensator 100,

Each of the upper outer body 110a and lower outer body 110b define a flat meeting surface which contact each other and are flush with each other when the upper outer body 110a is arranged on top of lower outer body 110b. Furthermore, each of the upper outer body 110a and lower outer bodies 110b are made of a thermally conducive metal such as steel, although plastics may also be used. This flush arrangement and the material of the outer body 110 both facilitate the cooling effect of the cooling circuit 160 through the compensator 100.

The upper outer body 110a and lower outer body 110b are held together by a fixing means such as screws. Without said fixing means, the high pressures of the soda passing through the compensator 100 could force the upper outer body 110a and lower outer body 110b apart.

The cooling conduit 166 is sealed by a sealing means. Preferably, the sealing means takes the form of upper and lower O-rings 168, 169, each arranged between the upper and lower outer bodies 110a, 110b. The upper O-ring 168 may be arranged at the meeting of the upper and lower outer bodies 110a, 110b above the cooling conduit 166, while the lower O-ring 169 may be arranged at the meeting of the upper and lower outer bodies 110a, 110b below the cooling conduit 166. In this way, the upper O-ring 168 seals the cooling conduit 166 from the outside, while the lower O-ring 169 seals the cooling conduit 166 from the flow path of soda through the compensator 100.

Now the compensator 100 has been described, other aspects of the unit 1 will be described, beginning with the soda delivery system 200.

The soda delivery system 200 delivers cooled and carbonated soda to the compensator 100 both for cooling of the compensator 100 and for flow regulation by the compensator 100 for dispensing.

To this end, the soda delivery system 200 comprises a chiller-carbonator 220 for chilling and carbonating soda. The chiller-carbonator 220 maintains all the soda at the right temperature and carbonation both for cooling of the compensator via the cooling circuit 160, and also for dispensing and consumption.

The soda delivery system 200 comprises a first soda delivery conduit 230, a second soda delivery conduit 232, a third soda delivery conduit 234, a fourth soda delivery conduit 236, and a controller valve 240. Any suitable components may be used for these purposes.

The first soda delivery conduit 230 couples the chiller-carbonator 220 to the controller valve 240 and is for transporting cooled and carbonated soda water from the chiller-carbonator 220 to the controller valve 240.

The second delivery conduit 232 couples the controller valve 240 to the cooling inlet 162 and is for transporting cooled soda water from the controller valve 240 to the cooling inlet 162, for passage through the cooling conduit 166 and hence for cooling the compensator 100.

The third soda delivery conduit 234 couples the cooling outlet 164 to the chiller-carbonator 220 and is for transporting compensator-warmed soda that has passed through the cooling conduit 166 from the cooling outlet 164 to the chiller-carbonator 220 for re-cooling (and re-carbonation) thereby.

The fourth soda delivery conduit 236 couples the controller valve 240 to the inlet 140 of the compensator 100 and is for transporting cooled and carbonated soda water from the controller valve 240 to the inlet 140 of the compensator 100 for flow regulation by the compensator 100 and then dispensing.

The controller valve 240 is configurable in a first configuration and a second configuration. In the first configuration, the controller valve 240 directs soda water from the first soda delivery conduit 230 to the second delivery conduit 232 for circulation around the cooling circuit 160 and back towards the chiller-carbonator 220 for re-cooling and re-carbonation. In the second configuration, soda is still directed around the cooling circuit, and the controller valve 240 additionally directs soda water from the first soda delivery conduit 230 to the inlet 140 of the compensator 100 for flow regulation by the compensator 100 and then dispensing.

The controller valve 240 is arranged in the first configuration unless configured otherwise by the controller. When operated on by the controller, the controller valve 240 is arranged in the second configuration. In this way, soda is usually circulating the cooling circuit 160 to maintain coolness of the compensator 100 and also to prevent stagnation of the soda within the compensator 100, thereby keeping the carbonated beverage dispenser 1 ready for use. When operated on by the controller, for example because a user has provided a ‘dispense’ input, soda is then also directed to the inlet 140 of the compensator 100 for flow regulation by the compensator 100 and then dispensing.

The chiller-carbonator is preferably configured to pressurise the soda to between 80 and 100 PSI, and preferably 90 PSI, i.e., between 5.5 bar and 6.9 bar, and preferably 6.2 bar.

This provides a sufficient level of carbonation in the dispensed carbonated beverage for high quality carbonated beverages. This differs from the typical pressure of a soda gun, which is typically less than 60 PSI.

The mixing chamber 300 will now be described in more detail, with reference FIGS. 1, 8a, 8b and 9.

As best seen in FIG. 1, the mixing chamber 300 extends in a perpendicular axis P away from the outlet 150 of the compensator 100.

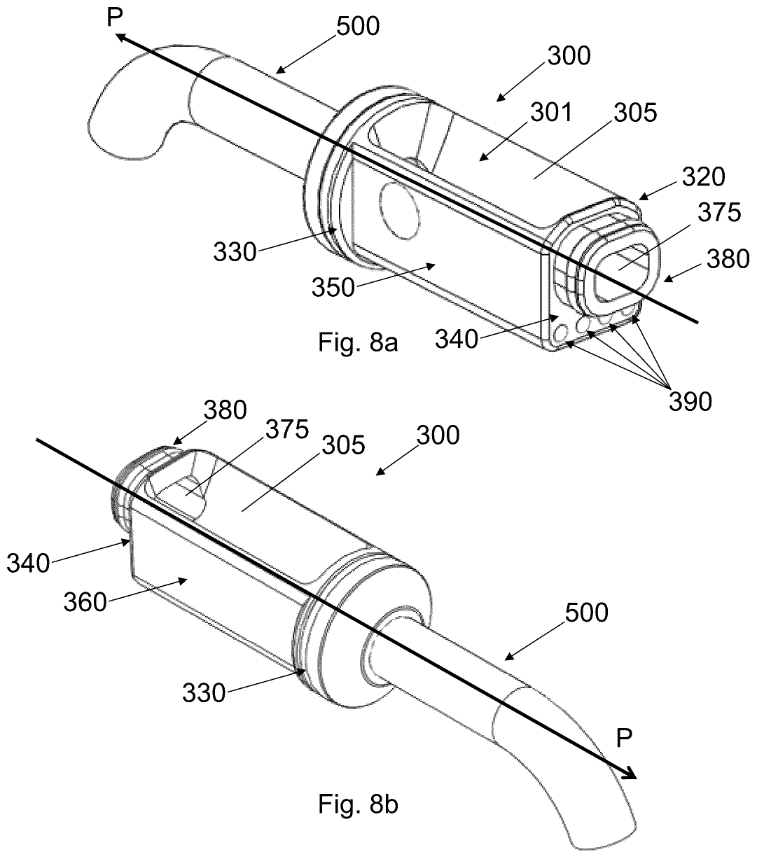

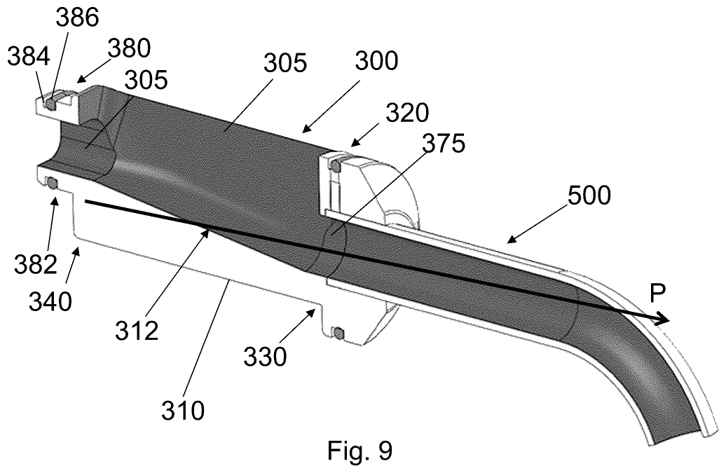

Referring to FIGS. 8a, 8b and 9, the mixing chamber 300 defines a body that is substantially cuboid in shape, and in this example is elongate along the perpendicular axis P. In other words, the body of the mixing chamber 300 has lower and upper walls 310, 320, front and back walls 330, 340 and first and second side walls 350, 360. The first and second side walls 350, 360 are longer than the front and back walls 330, 340.

The mixing chamber defines a cavity 301 therein, which receives and mixes carbonated water from the compensator 100, and additives from the additive dispensing system 400.

The cavity 301 has first, second and third distinct openings 305, 370, 375 defined therein. The first opening 305 extends across a length of the upper wall 320 of the mixing chamber 300 such that the mixing chamber 300 takes the form of a trough, being open at its top. The additive dispensing system 400 dispenses at least one additive into the mixing chamber 300 through the first opening 305. The volume defined by the mixing chamber 300 is sufficient such that liquids of the mixing chamber 300 do not overflow through the first opening 305.

The second opening 370 is defined in the back wall 340 for receiving soda from the outlet 150 of the compensator 100, and the third opening 375 is defined in the front wall 330 for delivering soda drink out of the mixing chamber 300. The second and third openings 370, 375 are therefore located on opposite ends of the mixing chamber 300.

As best seen in FIG. 9, opposite to the first opening 305 is a base surface 312 that defines a base of the cavity 301. The base surface 312 slopes downwardly moving from the second opening 370 to the third opening 375, thereby encouraging a flow of liquid towards the third opening.

The mixing chamber 300 is preferably removable from the compensator 100 of the carbonated beverage dispenser 1. This allows the mixing chamber 300 to be cleaned with ease. It is particularly beneficial that the mixing chamber 300 is easily cleanable, because the mixing chamber is in contact with the soda drink mixture (i.e., the mixture of carbonated water and syrup), which typically provides an environment in which mould can grow and is therefore particularly in need of regular cleaning.

To this end, the compensator 100 comprises a first connection part 158 defined by the second outlet channel 154 of the outlet 150, and the mixing chamber 300 comprises a second connection part 380 extending from the back wall and around the second opening. In this example, the second connection part 380 is male, i.e., comprises a projection in the form of a collar 382, while the first connection part 158 is female, i.e., comprises a receptacle in the form of a socket 159, although alternative arrangements are foreseen too. The two connection parts 158, 380 are configured such that they are connectable with a frictional fit. This therefore ensure a firm coupling of the mixing chamber 300 to the compensator 100, where the coupling can be quickly and easily connected and disconnected.

In this example, an O-ring 386 is used to enhance the frictional fit. As best seen in FIG. 9, the collar 382 of the second connection part comprises a circumferential channel 384 in its outer surface that houses an O-ring 386. As best seen in FIG. 1, when the mixing chamber 300 is arranged so that the collar 382 is inserted into the socket 159, the O-ring 386 provides a tight sealing contact against an internal surface of the collar 382 to hold the mixing chamber 300 in place.

The connection between the mixing chamber 300 and the compensator arrangement 100 is also magnetised: to this end, one or more first magnetic elements may be housed in or adjacent to the collar 382 and/or socket 159. The magnetisation provides a particularly secure fit and can also guide the collar 382 into the socket 159, to assist the user in fitting the mixing chamber in place.

The magnetic connection can also be combined with a sensor to detect whether the mixing chamber is in place, and thus can be used as a ‘switch’. To this end, the sensor can take the form of one or more second magnetic elements that are also housed in or adjacent to the collar 382 and/or socket 159 and which sense when a magnetic connection has not been made. In some embodiments, the first and second magnetic element(s) are the same, in others they are separate. Alternatively, the sensor may be a touch sensor or any other suitable type of sensor. Regardless, the control unit will not permit the unit to dispense any liquid when the mixing chamber is detected to be not in place, thereby avoiding accidental use of the unit without the mixing chamber being in place.

Alternatively, the mixing chamber 300 and the compensator arrangement 100 can be attached by way of a rubber seal. In this embodiment, a mechanical (instead of magnetic) switch can be provided on the compensator 100. In this embodiment, the control unit will not permit the compensator 100 to dispense any liquid unless the mechanical switch is operated by the user (i.e., to indicate that the mixing chamber 300 is correctly arranged in place with respect to the compensator 100).

The mixing chamber 300 is preferably thermally coupled to the outer body 110 of the compensator 100 when attached thereto. In this way, the cooling of the compensator 100 can be used to cool the mixing chamber 300 too, thus reducing the likelihood of outgassing. To this end the mixing chamber 300 may be made of a thermally conducive metal such as steel, although plastics may also be used. Plastic may be preferred because it results in a simplified manufacturing process and reduced costs—all plastic parts may be moulded separately and then welded together. Also, plastic has been found to ensure sufficient heat transfer, and it can be easier to achieve a much smoother finish on plastic parts than on metal counterparts. Preferably, the mixing chamber 300 is made of material such that it is also dishwasher safe, since this is the part that is to be cleaned.

The additive dispensing system 400 will now be described, with further reference to FIG. 1.

To dispense at least one additive into the mixing chamber 300 through the first opening 305, the additive dispensing system 400 comprises at least one additive dispenser 410 preferably in the form of at least one dispensing nozzle extending vertically downward. The additive dispensing system 400 further comprises at least one additive store 420 for storing the additive(s), and at least one additive delivery conduit 430 for transporting additive from the additive store(s) 432 to the respective additive dispenser 410 for dispensing.

The at least one additive dispenser 410 is arranged above the first opening 305 of the mixing chamber 300 such that the spacing S is defined therebetween. In this way, the additive dispenser 410 never touches the liquids in mixing chamber 300, and so will never be contaminated thereby. Hence, the additive dispensers 410 do not need to be cleaned as frequently as the mixing chamber.

Preferably, the additive dispensing system 400 comprises a plurality of additive dispensers 410 each arranged to dispense an additive into the mixing chamber 300 through the first opening 305, a plurality of additive stores 420 for storing each additive, and a plurality of additive delivery conduits 430 for transporting additive from each additive store 432 to the respective additive dispenser 410 for dispensing. This configuration is preferable as it avoids contamination of additives, and hence reduces the need for cleaning.

Turning now to the carbonated beverage outlet 500, with reference to FIGS. 8a, 8b and 9, the carbonated beverage outlet 500 takes the form of a circular spout that extends away from the third opening of the mixing chamber 300 along the perpendicular axis P, and curves downwards towards its end.

The carbonated beverage outlet 500 is preferably fixedly connected to the front wall 330 of the mixing chamber 300 such that both the mixing chamber 300 and the carbonated beverage outlet 500 are removable from the carbonated beverage dispenser 1. The two components 300, 500 can instead be integrally formed. This allows the carbonated beverage outlet 500 to be cleaned with ease along with the mixing chamber 300.

The carbonated beverage outlet 500 is preferably thermally coupled to the mixing chamber 300 and the outer body 110 of the compensator 100. In this way, the cooling of the compensator 100 can be used to cool the carbonated beverage outlet 500 too, thus reducing the likelihood of outgassing in the dispensed carbonated beverage. To this end the carbonated beverage outlet 500 may be made of a thermally conducive metal such as steel, although other materials such as other metals, or plastics may also be used too. Plastic may be preferred because it results in a simplified manufacturing process and reduced costs—all plastic parts may be moulded separately and then welded together. Also, plastic has been found to ensure sufficient heat transfer, and it can be easier to achieve a much smoother finish on plastic parts than on metal counterparts. Preferably, the carbonated beverage outlet 500 is made of material that is fully dishwasher safe, since it is to be cleaned regularly.

In reference to the above-described components of the carbonated beverage dispenser 1, it should be noted that the outer surface of the inner body 130, an inner surface of the inlet 140, an inner surface of the outlet 150, an inner surface of the mixing chamber 300, and an inner surface of the carbonated beverage outlet 500 all preferably have a surface roughness of no more than 0.1 microns Ra. This smoothness reduces nucleation sites for bubble formation, hence reducing outgassing in the dispensed mixed soda. By ensuring that these surfaces in particular have a high degree of smoothness, outgassing can be minimised.

Finally, the control unit (not shown) of the carbonated beverage dispenser 1 will be described.

The control unit provides electrical control of the carbonated beverage dispenser 1. The carbonated beverage dispenser 1 is also provided with a user input interface electrically coupled to the control unit. By way of this input, a user can input a selection of variables, including for example which carbonated beverage to dispense, and what volume of such beverage. On this basis, the control unit controls the operation of a control valve in the or each additive dispenser 410 to produce a particular carbonated beverage, and to dispense a particular volume.

During each dispensing operation, i.e., the production and dispensing of a particular soda drink, the control unit controls dispense of the carbonated water and the additive into the mixing chamber 300 separately. The control unit is configured to stop the additive being dispensed from additive dispensing system 400 a short time before it stops soda being dispensed the compensator 100. This means that at the end of any dispense cycle, the final liquid present in the mixing chamber 300 is only carbonated water, rather than the soda drink mixture. This final amount of carbonated water acts to clean the mixing chamber 300 at the end of every dispense cycle, to prevent flavour cross-over with the next soda drink being prepared, and to keep the mixing chamber 300 as clean as possible during use of the unit.

To this end, the inlet 140 of the compensator 100 may be provided with the controller valve 240 to control whether soda is delivered to the compensator 100, and hence to the mixing chamber 300. A control valve (not shown) in the or each additive dispenser 410 controls whether additive is delivered to the mixing chamber 300. The control unit is electrically coupled to each of the controller valve 240 and/or the or each additive dispenser valve 410, to control dispense of the carbonated water and the additives.

The same control unit may also be configured to detect the magnetic interlock 390 between the mixing chamber 300 and the compensator 100, and to prevent the dispense of liquids if the mixing chamber 300 is disconnected, as has already been described.

Variations on the carbonated beverage dispenser 1 described above will also be apparent to the skilled person that do not depart from the scope of the appended claims.

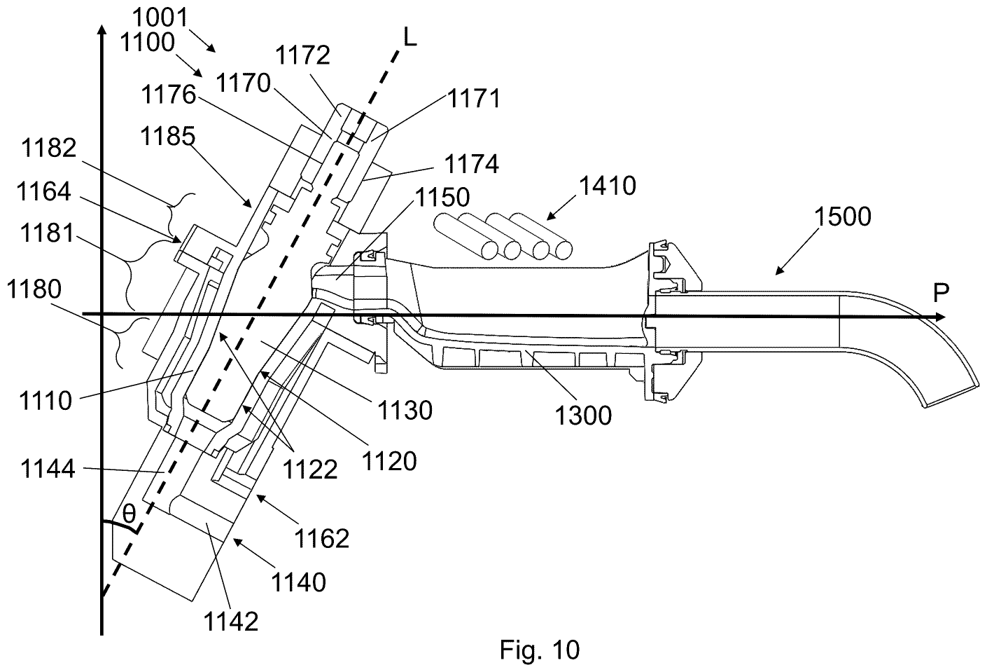

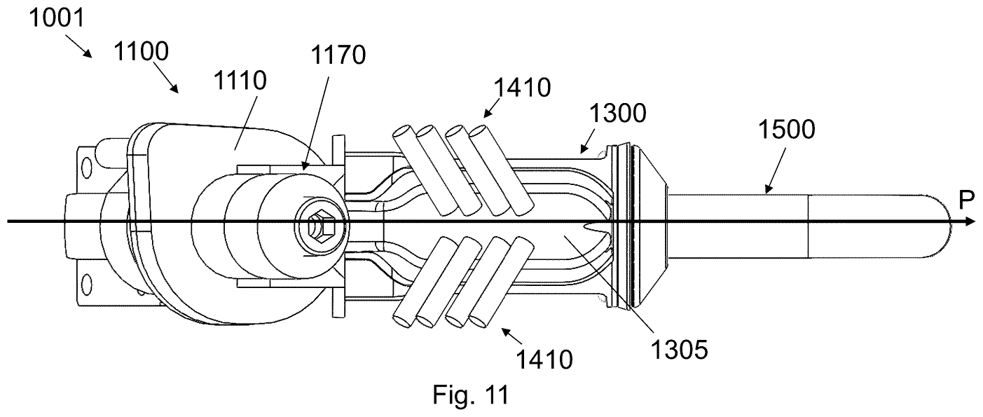

FIGS. 10 and 11 show an alternative embodiment of the carbonated beverage dispenser 1001, This embodiment is the same as the above embodiment, except that (1) the compensator 1100 of the carbonated beverage dispenser 1001 is arranged at a different, non-vertical orientation, (2) the control element 1170 has a different configuration, (3) the cooling circuit 1160 has a different configuration, and (4) at least one additive dispenser 1410 is arranged at a different, non-vertical orientation, as will be described below. The skilled person appreciates that these features are not interrelated—there are other embodiments that include one or some of these features in every combination.

In relation to the orientation of the compensator 1100, the longitudinal axis L, along which the compensator 1100, and the inner and outer bodies 1130, 1110 extend, is not arranged vertically but is instead arranged to extend upwardly and at angle θ with respect to the vertical. In other words, compensator 1100 is arranged/tilted/slanted at angle θ with respect to the vertical direction. Angle θ is preferably between around 20 and 85°, more preferably between around 40 and 80°, more preferably between around 50 and 70°, more preferably around 55 and 65°, and more preferably around 60°.

In this embodiment, because the compensator 1100 extends upwardly at an angle, the first region or upstream region 1180 of the compensator body 1130 is a lower region 1180 and the second region or downstream region 1182 of the compensatory body 1130 is an upper region 1182. The inlet 1140 opens into the first region 1180 and the outlet 1150 opens into the second region 1182: in this way, the inlet 1140 is arranged below the outlet 1150, so that soda therefore travels upwards (instead of downwards) through the gap 1122 defined between the inlet 1140 and outlet 1150. The pressure differential across the compensator 1120 provides this movement of soda therethrough.

In this embodiment, the outlet 1150 of the compensator 1100 is not L shaped and instead only extends in one direction, namely along perpendicular axis P. The outlet 1150 of the compensator 1100 extends out the side of the second region 1182 of the compensator chamber 1120. In other words, one end of the outlet 1150 is fluidly connected to the second region 1182 of the compensator chamber 1120 and receives regulated soda therefrom. The other end of the outlet 1150 is fluidly connected to the mixing chamber 1300 and delivers regulated soda therein. The mixing chamber 1300 and the carbonated beverage outlet 1500 both extend along perpendicular axis P away from the outlet 1150 of the compensator 1100.

The inlet 1140 remains L shaped in this embodiment, but in this embodiment the inlet 1140 delivers fluid into the first region 1180 of the compensator chamber 1120 along longitudinal axis L. To this end, the first inlet channel 1142 extends upwards at an angle perpendicular to longitudinal axis L, while the second inlet channel 1144 extends upwards along longitudinal axis L through the outer body 1110 of the compensator 1100 and into the compensator chamber 1120. In this way, the configuration of the inlet 1140 is tilted/slanted compared to the first embodiment.

In this embodiment, the shape of the inner and outer bodies 1130, 1110 is the same, but inverted. In other words: In the first region 1180, the diameter of the inner body 1130 and the diameter of the compensator chamber 1120 are preferably approximately constant when moving upwardly along the longitudinal axis L. In the middle region 1181, the diameter of the inner body 1130 and the diameter of the compensator chamber 1120 increase at substantially the same fixed rate when moving upwards along the longitudinal axis L. In the second region 1182, the diameter of the inner body 1130 and of the compensator chamber 1120 decrease at different fixed rates when moving upwards along the longitudinal axis L. In particular, the angle defined between the outer surface of the inner body 1130 and longitudinal axis L is slightly less than the angle defined between the inner surface of the outer body 1110 and longitudinal axis L at each point along the longitudinal axis L in the upper region 1182 of the compensator 1100, so the gap 1122 between the inner and outer bodies 1130, 1110 increases moving up along longitudinal axis L in the upper region 1182.

In this embodiment, the control element 1170 is arranged at a downstream end of the compensator 1100, i.e., downstream of the second region 1182 of the compensator body 1100.

The control element 1170 takes the form of a differential screw in the manner described above but has a different configuration. In this example, the control element 1170 comprises a collar 1171 having an outer surface 1174 and an inner surface 1176. The outer surface 1174 defines a first portion that is configured to engage with the outer body 1110 of the compensator assembly 1100, and the inner surface 176 defines a second portion that is configured to engage with the inner body 1130 of the compensator 1100. In this way, the collar 1171 is located between the inner and outer bodies 1130, 1110 of the compensator 1100.

The differential screw of the control element 1170 operates in substantially the same way described above. The outer surface 1174 is provided with a first thread and the inner surface 1176 is provided with a second thread, with the first and second threads each having a different pitch. The outer body 1110 and inner body 1130 are each provided with corresponding threads. Due to the different pitches, rotation of the control element 1170 causes the inner and outer bodies 1110, 1130 to move along the longitudinal axis L by different amounts, causing relative displacement between the inner and outer bodies 1110, 1130, thereby adjusting the size of the gap 1122 between the bodies 1110, 1130 in the manner already described above. Other features of the control element 1170, such as the sizes and pitch of the screw thread may be the same as the embodiment above.

The control element 1170 may also be provided with an engagement portion 1172 that protrudes out of the outer body 1130 to facilitate engagement by a user. In this embodiment, the engagement portion 1172 may be an end region of the collar 1171.

The above-described tilted arrangement of the compensator 1100 and collar arrangement of the control element are advantageous because they provide a particularly compact and simple arrangement of the compensator system.

In relation to the cooling circuit 1160, the cooling circuit 1160 also has a different configuration in FIG. 10 compared to FIG. 1. In more detail, the cooling inlet 1162 still extends into the outer body 1110 through the base of the outer body 1110; however, instead of exiting through the base of the outer body 1110, the cooling outlet 1164 exits the outer body 1110 through the top of the outer body 1110. Locating the outlet 1164 at the top (as opposed to at the bottom) of the outer body 1110 is advantageous since it reduces the incidence of bubbles getting trapped in the cooling circuit 1160.

Turning to the additive dispenser 1410, the additive dispenser 1410 still takes the form of one or more dispensing nozzles. In this embodiment, the or each nozzle is tilted at an angle with respect to the vertical such that it dispenses an additive into the mixing chamber 1300 along the direction of flow through the mixing chamber 1300, i.e., along axis P. Additionally or alternatively, each dispensing nozzle may be tilted with respect to angle P such that it dispenses an additive inwardly (i.e., laterally) into the mixing chamber 1300 from outside of the mixing chamber 1300 from either side of the mixing chamber 1300 about axis P.

As shown in FIG. 11, in an example where there is a plurality of dispensing nozzles, half of the dispensing nozzles are arranged to dispense an additive from one side of the mixing chamber 1300 and half from the other side. The nozzles are arranged symmetrically about axis P. These tilted arrangements of the additive dispenser 1410 are advantageous because they avoid liquid being splashed out of the top of the mixing chamber 1300 as the additives are dispensed.

Alternatively, the dispensing nozzles may be split into a first plurality or bundle of dispensing nozzles for dispensing “base” syrups and a second plurality of bundle of dispensing nozzles for dispensing “flavour liquids”. The first bundle may be tilted in one or two of the directions mentioned above, while the second bundle may be arranged to extend directly down along the vertical. Only the nozzles that dispense “base” syrups are angled in the direction of flow in this embodiment because the flow rate of these syrups is larger than of the flavour liquids.

Other variations and modifications are envisaged without departing from the scope of the appended claims.

What is claimed is:

1. A carbonated beverage dispenser for dispensing a carbonated beverage comprising soda and at least one additive, the carbonated beverage dispenser comprising a compensator for regulating the flow rate of soda, the compensator comprising:
an outer body defining a compensator chamber,
an inlet for delivering soda into the compensator chamber, and an outlet for delivering soda out of the compensator chamber,
an inner body arranged within the compensator chamber and between the inlet and the outlet, wherein a gap is defined between the inner body and the outer body for regulating the flow rate of soda passing between the inlet and the outlet, and
a control element configured to receive a user input from a user and to control the size of the gap in dependence on said user input, wherein, for a given user input, the control element moves the inner body relative to the control element to a first extent and the outer body relative to the control element to a second extent, the first extent being non-equal to the second extent.

2. The carbonated beverage dispenser of claim 1, wherein the control element is rotatable, and wherein the user input is a rotation of the control element.

3. The carbonated beverage dispenser of claim 1, wherein the control element takes the form of a differential screw with a first portion comprising a first thread for engaging the outer body and a second portion comprising a second thread for engaging the inner body, the first thread having a different thread pitch to the second thread.

4. The carbonated beverage dispenser of claim 3, wherein the first thread has a pitch of between 0.65 and 0.85 mm, and wherein the second thread has a pitch of between 0.9 mm and 1.1 mm.

5. The carbonated beverage dispenser of claim 2, wherein for a full rotation of the control element, the control element causes relative longitudinal displacement between the inner and outer bodies of between 0.20 mm and 0.30 mm.

6. The carbonated beverage dispenser of claim 1, wherein the inner body is non-rotational with respect to the outer body.

7. The carbonated beverage dispenser of claim 1, wherein the control element comprises an engagement portion that protrudes out of the outer body to define an engagement feature for engagement by a user.

8. The carbonated beverage dispenser of claim 1, wherein the compensator further comprises a cooling conduit arranged within the outer body, wherein said cooling conduit is configured to receive a cooling liquid.

9. The carbonated beverage dispenser of claim 1, wherein the compensator comprises a first region proximal to the inlet, a second region proximal to the outlet, and a middle region therebetween.

10. The carbonated beverage dispenser of claim 9, wherein, in the first region, a diameter of the inner body and a diameter of the compensator chamber are approximately constant between the inlet and the middle region.

11. The carbonated beverage dispenser of claim 9, wherein, in the middle region, the or a diameter of the inner body and the or a diameter of the compensator chamber increase at substantially the same fixed rate between the first and the second regions.

12. The carbonated beverage dispenser of claim 9, wherein, in the second region, the or a diameter of the inner body and of the compensator chamber decrease at different fixed rates between the middle region and the outlet.

13. The carbonated beverage dispenser of claim 8, wherein the carbonated beverage dispenser further comprises a soda delivery system comprising a chiller-carbonator for chilling and carbonating soda for the compensator.

14. The carbonated beverage dispenser of claim 13, wherein the soda delivery system further comprises a first soda delivery conduit for transporting soda from the chiller-carbonator to the cooling conduit for cooling the compensator.

15. The carbonated beverage dispenser of claim 13, wherein the soda delivery system further comprises a second soda delivery conduit for transporting soda water from the chiller-carbonator to the compensator for flow-regulation, when selectively operated by a user.

16. The carbonated beverage dispenser of claim 13, wherein the chiller-carbonator is configured to pressurise soda to between 5.5 bar and 6.9 bar, and preferably 6.2 bar.

17. The carbonated beverage dispenser of claim 1, wherein the carbonated beverage dispenser further comprises an additive dispensing system for dispensing at least one additive, and a mixing chamber for receiving soda from the compensator and at least one additive from the additive dispensing system and mixing the soda with at least one additive to form a soda-based drink.

18. The carbonated beverage dispenser of claim 17, wherein the mixing chamber further comprises a first opening arranged in the mixing chamber, and wherein the additive dispensing system comprises at least one additive dispenser arranged to dispense at least one additive into the mixing chamber through the first opening, wherein a spacing is defined between the at least one additive dispenser and the mixing chamber.

19. The carbonated beverage dispenser of claim 18, wherein the first opening is defined in an upper wall of the mixing chamber, and wherein the at least one additive dispenser is arranged above the mixing chamber.

20. The carbonated beverage dispenser of claim 17, wherein the mixing chamber further comprises a second opening for receiving soda from the outlet of the compensator, and a third opening for delivering carbonated beverage out of the mixing chamber.

21. The carbonated beverage dispenser of claim 17, wherein the carbonated beverage dispenser comprises a control unit for controlling the carbonated beverage dispenser during dispensing operations, wherein, the control unit is configured to control a dispensing flow of soda and additive such that, at the end of each dispensing operation, the last liquid that passes through the mixing chamber is soda, with no dispensed additive(s).

22. The carbonated beverage dispenser of claim 21, wherein the control unit is configured to stop the additive dispensing system dispensing an additive into the mixing chamber before the control unit stops the compensator dispensing soda into the mixing chamber.

23. The carbonated beverage dispenser of claim 20, wherein the mixing chamber is removable from the carbonated beverage dispenser.

24. The carbonated beverage dispenser of claim 23, wherein the compensator comprises a first connection part about the outlet, and wherein the mixing chamber comprises a second connection part about the second opening, wherein one of the first and second connection parts is male and the other is female, and wherein the first and second connection parts fit with a frictional fit.

25. The carbonated beverage dispenser of claim 23, wherein the carbonated beverage dispenser comprises the or a control unit for controlling the operation of the carbonated beverage dispenser, wherein the control unit is configured to detect whether the mixing chamber has been removed from the carbonated beverage dispenser, and to prevent the compensator and/or the additive dispensing system from dispensing when the mixing chamber has been removed from the carbonated beverage dispenser.
